(19) United States
(12) Patent Application Publication
(10) Pub. No.: US 2011/0306391 A1
(43) Pub. Date: Dec. 15, 2011

(54) Transmitter architecture enabling efficient preamplification gain control and related method

(75) Inventors: Ahmad Mirzaei, San Diego, CA (US); Dmitriy Rozenblit, Irvine, CA (US); Hooman Darabi, Laguna Niguel, CA (US); Masoud Kahrizi, Irvine, CA (US)

(73) Assignee: BROADCOM CORPORATION, Irvine, CA (US)

(21) Appl. No.: 12/802,603

(22) Filed: Jun. 9, 2010

(51) Int. Cl. H04W 52/04

(52) U.S. Cl. 455/571

(57) ABSTRACT

According to one embodiment, a radio frequency (RF) transceiver includes a transmitter enabling efficient preamplification gain control. The RF transceiver comprises a receiver and a power amplifier (PA) for amplifying a transmit signal of the transmitter. The transmitter is configured to provide pre-PA gain control for preamplifying the transmit signal before amplification by the PA, wherein substantially all of the pre-PA gain control is provided when the transmit signal is at a transmit frequency of the transmitter. In one embodiment, the transmitter includes a PA driver comprising in combination: a transconductance amplifier, a current steering block, and an output transformer. Each of the transconductance amplifier, current steering block, and output transformer is configured to contribute a respective variable gain control to the pre-PA gain control provided by the PA driver.

### BACKGROUND OF THE INVENTION

1. Field of the Invention

The present invention is generally in the field of electronic circuits and systems. More specifically, the present invention is in the field of communications circuits and systems.

2. Background Art

Transceivers are typically used in communications systems to support transmission and reception of communications signals through a common antenna, for example at radio frequency (RF) in a cellular telephone or other mobile communication device. A transmitter routinely implemented in such a transceiver in the conventional art may utilize several processing stages to condition and preamplify a transmit signal prior to passing the transmit signal to a power amplifier (PA). For example, the transmit signal may originate as a digital signal generated by a digital block of the transmitter. That digital signal is then typically converted into an analog baseband signal, by means of a digital-to-analog converter (DAC), for example. The analog baseband signal may then be filtered using a low-pass filter (LPF) and up-converted to RF by a mixer, which is usually implemented as an active circuit. Subsequently, the up-converted signal can be processed by a PA driver, which then passes the preamplified transmit signal to the PA for final amplification and transmission from the transceiver antenna.

In a conventional transmitter, the pre-amplification, or pre-PA gain control, provided by the transmitter as a whole may be approximately evenly distributed between lower frequency gain control stages implemented prior to or in combination with up-conversion, and higher frequency gain control stages following up-conversion. In that conventional design approach, the DAC, LPF, and mixer circuits may collectively contribute a significant portion of the overall gain control, such as approximately fifty percent of the preamplification gain control, for example.

However, this conventional approach is associated with significant disadvantages, owing in part to the substantial inefficiencies resulting from the time and iterative testing required to coordinate calibration amongst the various lower frequency and higher frequency gain control stages. For instance, because calibrating the active mixer used in a conventional transmitter can affect the gain control provided by the mixer during up-conversion, one or more stages of the PA driver providing higher frequency gain control must typically be adaptively calibrated to compensate for the variation in gain control seen in the mixer, in order to assure that a desirable overall level of preamplification gain control is provided by the transmitter.

Thus, there is a need to overcome the drawbacks and deficiencies in the art by providing a transmitter architecture enabling efficient preamplification gain control and suitable for implementation as part of a more modern mobile device transceiver.

### SUMMARY OF THE INVENTION

The present invention is directed to a transmitter architecture enabling efficient preamplification gain control and related method, substantially as shown in and/or described in connection with at least one of the figures, and as set forth more completely in the claims.

### BRIEF DESCRIPTION OF THE DRAWINGS

FIG. 1 is a conceptual block diagram of a conventional transmitter included in a transceiver.

FIG. 2 is a conceptual block diagram of a transceiver including a transmitter enabling efficient preamplification gain control, according to one embodiment of the present invention.

FIG. 3 shows a block diagram of a transmitter enabling efficient preamplification gain control and including a feedback calibration stage, according to one embodiment of the present invention.

FIG. 4 illustrates an example power amplifier (PA) driver including a plurality of variable gain stages configured to enable efficient preamplification gain control by a transmitter, according to one embodiment of the present invention.

FIG. 5 is a flowchart presenting a method for use by a transmitter to provide efficient preamplification gain control, according to one embodiment of the present invention.

### DETAILED DESCRIPTION OF THE INVENTION

The present invention is directed to a transmitter enabling efficient preamplification gain control and a related method. Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

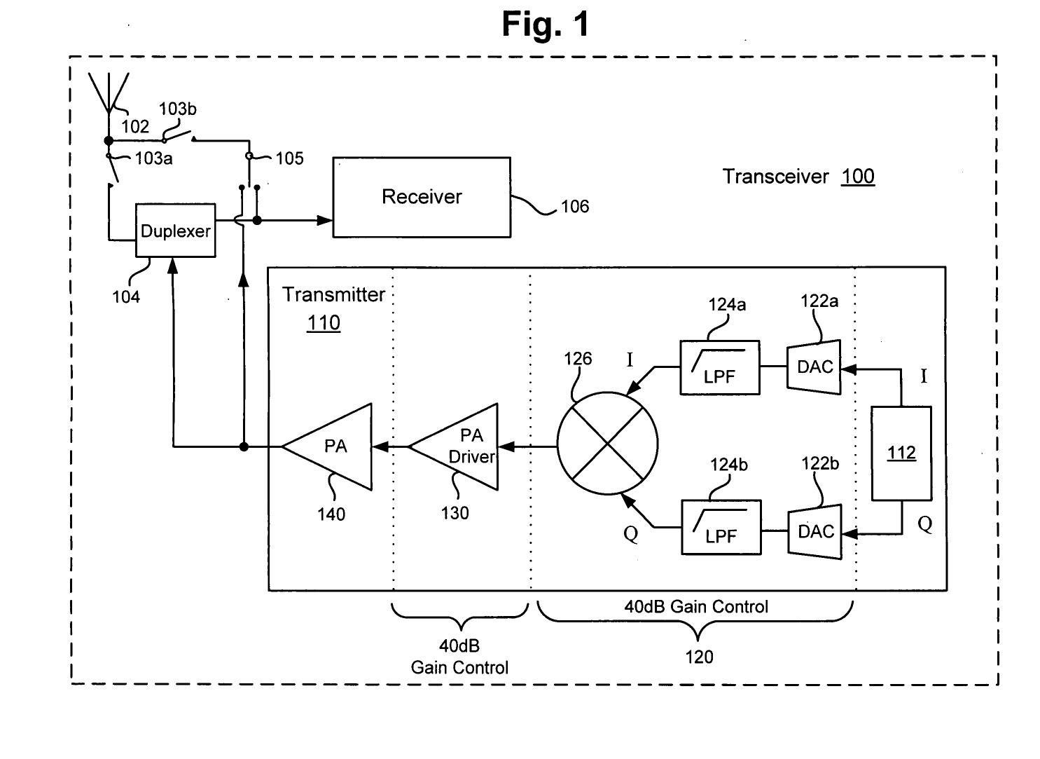

FIG. 1 is a conceptual block diagram of transceiver 100 including a conventional transmitter implementation. Transceiver 100 comprises antenna 102, transceiver input/output routing switches 103a and 103b, duplexer 104, transmit/receive T/R switch 105, receiver 106, and conventional transmitter 110. As shown in FIG. 1, conventional transmitter 110 includes power amplifier (PA) 140, which can be coupled to antenna 102 of transceiver 100 either through T/R switch 105 and transceiver input/output routing switch 103b or through duplexer 104 and transceiver input/output routing switch 103a depending, for example, upon whether transceiver 100 is operating respectively in a second-generation wireless telephone technology (2G) or a 3G communication mode. As further shown in FIG. 1, conventional transmitter 110 includes a front-end comprising digital block 112 providing in-phase (I) and quadrature phase (Q) outputs to respective digital-to-analog converters (DACs) 122a and 122b. In addition, and as also show in FIG. 1, conventional transmitter 110 includes low-pass filters (LPFs) 124a and 124b, mixer 126 to combine and up-convert the I and Q signals, and PA driver 130 providing a preamplified transmit signal to PA 140.

As indicated in FIG. 1, in a conventional approach to implementing a transmitter in a communications transceiver, such as transmitter 110 included in transceiver 100, the preamplification gain control provided by the transmitter (hereinafter “pre-PA gain control”) is approximately evenly divided between lower frequency and higher frequency gain control stages. For example, PA driver 130 typically provides approximately fifty percent of the pre-PA gain control, and does so at higher frequency after up-conversion, e.g., at a transmit frequency of transmitter 110, such as at radio frequency (RF). By contrast, lower frequency gain control stage 120 including DACs 122a and 122b, LPFs 124a and 124b, and mixer 126 typically also provides approximately fifty percent of the pre-PA gain control, but does so at lower frequencies, e.g., either prior to or concurrently with up-conversion by mixer 126. As shown, for example, in FIG. 1, conventional transmitter 100 may provide approximately 80 dB of pre-PA gain control, of which approximately 40 dB is contributed by each of lower frequency gain control stage 120 and PA driver 130.

Reliance on a pre-PA gain control scheme in which gain control is distributed over several stages spanning both lower and higher frequencies, as represented in FIG. 1, comes at a considerable price in terms of operational efficiency, however. For example, as known in the art, the gain control provided by, for instance, LPFs 124a and 124b, or mixer 126, can vary with their calibration. Consequently, in order to meet the overall pre-PA gain requirements of transmitter 100, PA driver 130 must typically be adaptively calibrated to compensate for the change in gain control provided by lower frequency gain control stage 120 owing to its own calibration. Consequently, provision of accurate pre-PA gain control using the conventional implementation represented in FIG. 1 requires an iterative testing and calibration process that is both intrinsically inefficient and operationally costly. Moreover, as communications technologies continue to move in the direction of smaller device dimensions, higher device and system speeds, and smaller power supplies, as represented, for example, by the 40 nm technology node, the fundamental inefficiency embodied by conventional transmitter 110 becomes increasingly incongruous and undesirable.

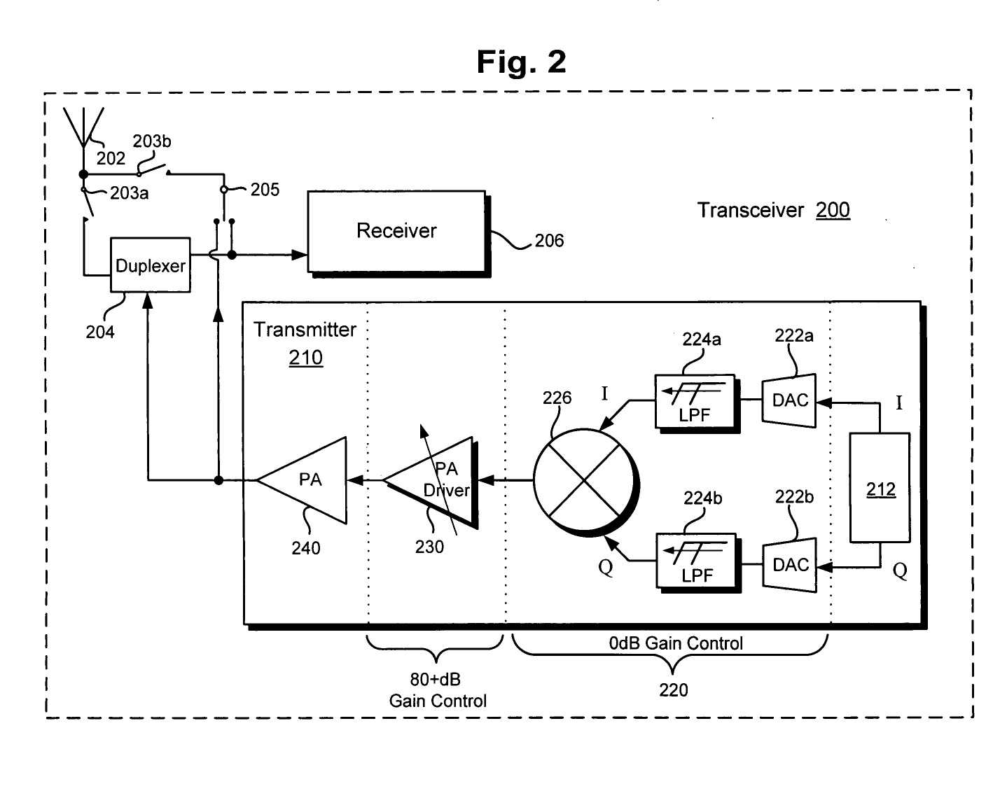

Turning to FIG. 2, FIG. 2 shows a conceptual block diagram of transceiver 200 including transmitter 210 enabling efficient pre-PA gain control, according to one embodiment of the present invention, capable of overcoming the disadvantages associated with the conventional design described above in relation to FIG. 1. It is noted that the arrangement shown in FIG. 2 is for the purpose of providing an overview, and elements shown in that figure are conceptual representations of physical and electrical elements, and are thus not intended to show dimensions or relative sizes or scale.

In addition to transmitter 210, transceiver 200 comprises antenna 202, transceiver input/output routing switches 203a and 203b, duplexer 204, T/R switch 205, and receiver 206 for processing a receive signal of transceiver 200. As shown in FIG. 2, transmitter 210 includes PA 240, which can be coupled to antenna 202 of transceiver 200 either through T/R switch 205 and transceiver input/output routing switch 203b or through duplexer 204 and transceiver input/output routing switch 203a to support a respective 2G or 3G communication mode, for example. As further shown in FIG. 2, transmitter 210 includes a front-end comprising digital block 212 providing I and Q output signals to respective DACs 222a and 222b. In addition, and as also show in FIG. 2, transmitter 210 includes adjustable LPFs 224a and 224b, mixer 226 to combine and up-convert the I and Q signals filtered by adjustable LPFs 224a and 224b, and variable gain control PA driver 230 providing a preamplified transmit signal to PA 240. Transceiver 200, in FIG. 2, may be utilized in a cellular telephone or other mobile communication device operating at RF, for example, such as in a frequency range from approximately 0.8 GHz to approximately 2.2 GHz.

In marked contrast to the conventional transmitter implementation shown in FIG. 1, the embodiment of the present invention shown in FIG. 2 significantly increases the efficiency of the pre-PA gain control provided by transmitter 210. As shown in FIG. 2, for example, substantially all of the pre-PA gain control provided by transmitter 210 occurs after up-conversion of the transmit signal by mixer 226. That is to say, unlike conventional preamplification schemes, transmitter 210 provides substantially all pre-PA gain control at a transmit frequency of transmitter 210, such as at RF, for example. According to the embodiment of transceiver 200, substantially all of the approximately 80 dB, or more, of pre-PA gain control produced by transmitter 210 is provided by variable gain control PA driver 230, while low frequency stage 220 is relied upon for substantially none of that pre-PA gain control.

As described above in relation to FIG. 1, distribution of pre-PA gain control over both higher frequency and lower frequency gain control stages, as typically occurs in conventional transmitter implementations, comes at a considerable price in terms of operational efficiency and cost. By eliminating the conventional reliance on low frequency stage gain control, embodiments of the present invention significantly reduce the calibration and testing time required in transmitter 210, thereby reducing its cost of operation. In one embodiment, transmitter 210 can be implemented as an integrated circuit (IC) fabricated on a single semiconductor die using a 40 nm process technology, for example.

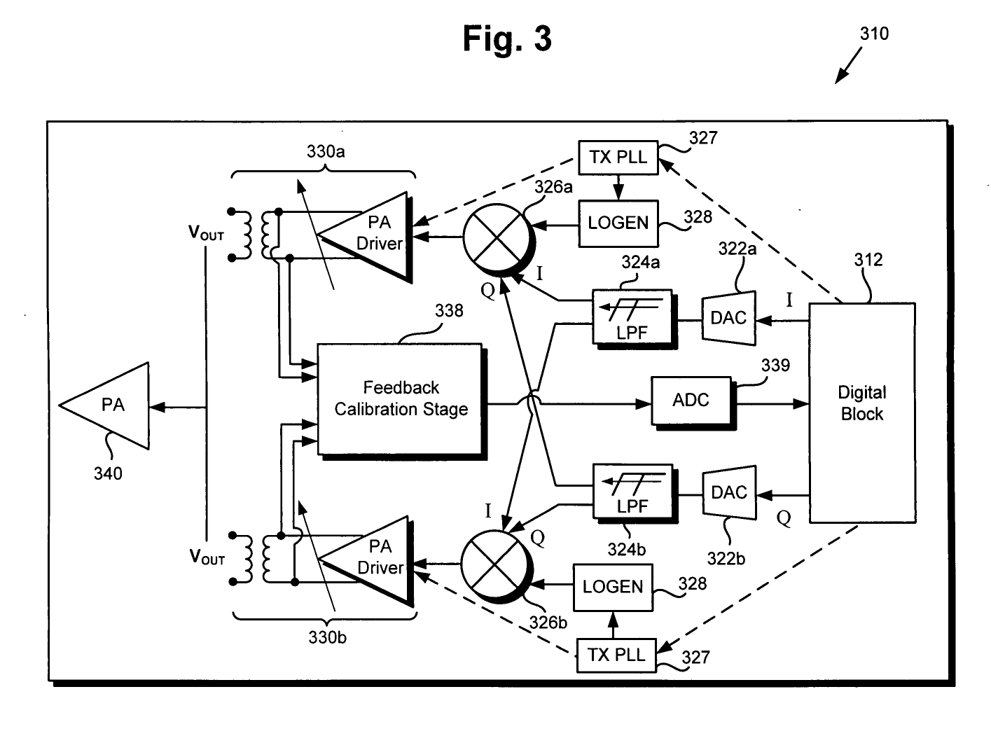

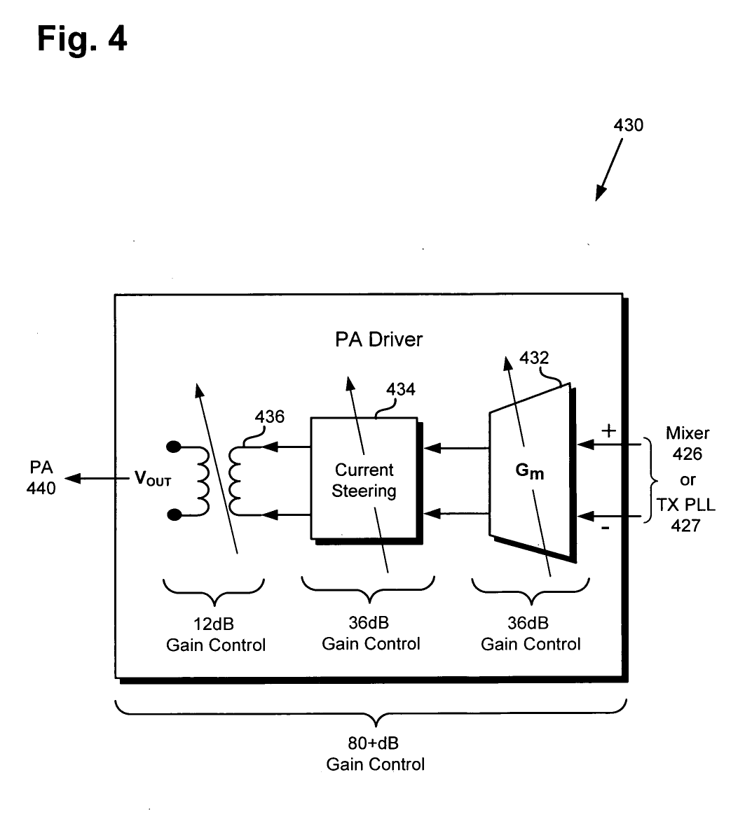

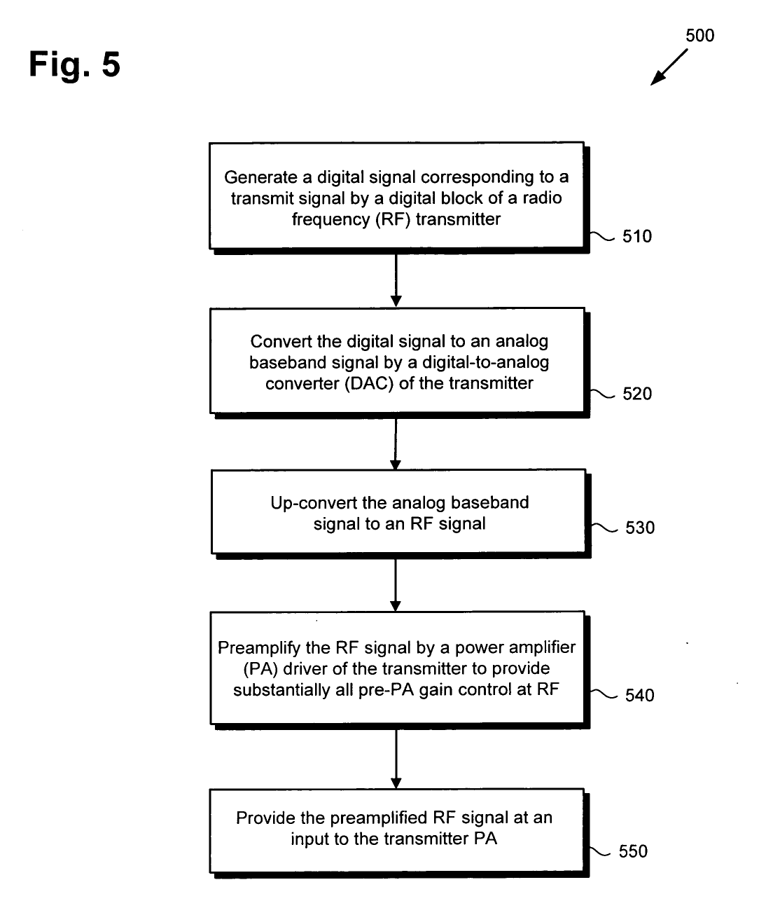

The operation of transmitter 210 enabling efficient pre-PA gain control will now be further described by reference to FIGS. 3, 4, and 5. FIG. 3 shows a block diagram of a transmitter enabling efficient pre-PA gain control and including a feedback calibration stage, according to one embodiment of the present invention, while FIG. 4 illustrates one embodiment of a variable gain control PA driver including a plurality of variable gain stages configured to enable efficient preamplification gain control. FIG. 5 is a flowchart presenting a method for use by a transmitter to provide efficient pre-PA gain control, according to one embodiment of the present invention.

Referring to FIG. 3, FIG. 3 shows transmitter 310 enabling efficient pre-PA gain control. In addition to providing efficient pre-PA gain control, exemplary transmitter 310 can be configured to enable self calibration for highly accurate gain control. Moreover, and as shown in FIG. 3, transmitter 310 may be configured to support multiple transmission modes and/or multiple transmission frequencies. For example, such a high-band transmission frequency range between approximately 1.9 GHz and 2.2 GHz, for example, and a low-band transmission frequency range between approximately 0.8 GHz and 1.1 GHz, for example. Transmitter 310 may correspond to transmitter 210, shown in FIG. 2.

As shown in FIG. 3, transmitter 310 comprises digital block 312, DACs 322a and 322b, adjustable LPFs 324a and 324b, and PA 340, corresponding respectively to digital block 212, DACs 222a and 222b, adjustable LPFs 224a and 224b, and PA 240, in FIG. 2. To support a high-band frequency channel as well as a low-band frequency channel, transmitter 310 in FIG. 3 includes respective mixers 326a and 326b, which may be implemented as passive circuits, for example, and correspond to single mixer 226 in FIG. 2. In addition, transmitter 310 includes high-band variable gain control PA driver 330a and low-band variable gain control PA driver 330b, either or both of which may be seen to correspond to variable gain control PA driver 230, in FIG. 2.

Also shown in FIG. 3 are transmitter phase-locked loop (TX PLL) 327 and local oscillator generator (LOGEN) 328, as well as feedback calibration stage 338 and ADC 339 providing digital calibration feedback to digital block 312. Although TX PLL 327 and LOGEN 328 are shown in duplicate in FIG. 3 for the purposes illustrative clarity, in practice, a single combination of TX PLL 327 and LOGEN 328 can be coupled to both variable gain control PA drivers 330a and 330b, and can be shared by respective high-band and low-band mixers 326a and 326b as well.

As mentioned above, the embodiment of FIG. 3 may be implemented to support multiple transmission modes, such as transmission modes employing quadrature modulation schemes and transmission modes employing polar modulation, for example. For instance, in FIG. 3, transmission modes employing quadrature modulation can be associated with the solid line signal paths linking I and Q outputs of digital block 312 to variable gain control PA drivers 330a and 330b through respective DAC/adjustable LPF/mixer combinations 322ab/324ab/326a and 322ab/324ab/326b. Analogously, transmission modes employing polar modulation can be associated with the dashed line signal paths linking digital block 312 to variable gain control PA drivers 330a and 330b through TX PLL 327.

It is noted that although the pre-PA signal paths shown in FIG. 3 are represented by single lines for simplicity, many of those signals can comprise paired differential signals. Thus, the I and Q outputs of digital block 312 passed to mixers 326a and 326b, the outputs of mixers 326a and 326b, the polar mode outputs of digital block 312 passed to variable gain control PA drivers 330a and 330b through TX PLL 327, and the feedback calibration signal returned to digital block 312, for example, can comprise differential signals. It is further noted that the signal paths internal to variable gain control PA drivers 330a and 330b, as well as the feedback signals provided by those variable gain control PA drivers to feedback calibration stage 338, are explicitly shown as differential signals. Moreover, the respective outputs of variable gain control PA drivers 330a and 330b, shown as V_{OUT}, are provided as single-ended inputs to PA 340.

As further shown in FIG. 3, the I and Q signal paths provided by respective DACs 322a and 322b and adjustable LPFs 324a and 324b can be shared between the high-band and low-band transmission signals. Moreover, digital block 312, TX PLL 327, LOGEN 328, feedback calibration stage 338, ADC 339, and PA 340 may be shared in common by all transmission modes and all transmission frequency bands. Consequently, transmitter 310 is characterized by a compact space saving architecture that may be particularly well suited to meet increasingly fine dimensional and lower power consumption constraints as fabrication technologies transition to the 40 nm node and beyond.

Turning to FIG. 4, FIG. 4 shows variable gain control PA driver 430 configured to enable efficient pre-PA gain control by a transmitter, according to one embodiment of the present invention. Variable gain control PA driver 430 can be seen to correspond to either of variable gain control PA drivers 330a or 330b, in FIG. 3, as well as to variable gain control PA driver 230, in FIG. 2. As shown in FIG. 4, according to the present embodiment, variable gain control PA driver 430 comprises a plurality of variable gain control stages including variable gain transconductance amplifier 432, variable gain current steering block 434, and variable gain output transformer 436.

According to the embodiment shown in FIG. 4, variable gain control PA driver 430 receives differential inputs from mixer 426 or TX PLL 427 (neither explicitly shown in FIG. 4), such as differential up-converted transmit signals, for example, and provides a preamplified transmit signal as a single ended output V_{OUT} to PA 440 (also not shown in FIG. 4). PA 440, output V_{OUT}, TX PLL 427, and mixer 426 correspond respectively to PA 340, output V_{OUT}, TX PLL 327, and either of mixers 326a or 326b, in FIG. 3. As in the embodiment of FIG. 2, variable gain control PA driver 430 is configured to provide approximately 80 dB or more of pre-PA gain control.

As shown in FIG. 4, in the present embodiment, approximately 36 dB of pre-PA gain control are provided by each of variable gain transconductance amplifier 432 and variable gain current steering block 434, while variable gain output transformer 436 provides an additional approximately 12 dB of gain control. Moreover, one or both of variable gain transconductance amplifier 432 and variable gain current steering block 434 can be implemented using respective arrays of selectable unit cells to provide accurate gain control steps of less than approximately 1.0 dB each, for example, such as approximately 0.5 dB of pre-PA gain control per unit cell.

Continuing now to FIG. 5, FIG. 5 presents flowchart 500 describing one embodiment of a method for use by a transmitter to provide efficient pre-PA gain control. Certain details and features have been left out of flowchart 500 that are apparent to a person of ordinary skill in the art. For example, a step may comprise one or more substeps or may involve specialized equipment or materials, as known in the art. While steps 510 through 550 indicated in flowchart 500 are sufficient to describe one embodiment of the present invention, other embodiments of the invention may utilize steps different from those shown in flowchart 500, or may comprise more, or fewer, steps. It is further noted that while the specific steps outlined by flowchart 500 may be seen to have particular relevance to certain transmission modes, for example, those employing quadrature modulation, the present inventive concepts are applicable to multi-mode capable transmitters. As a result, in other embodiments the described method steps may be suitably modified to provide efficient pre-PA gain control for transmission modes using other modulation schemes, such as polar modulation for example.

Proceeding with step 510 in FIG. 5, step 510 of flowchart 500 comprises generating a digital signal corresponding to a transmit signal by a digital block of an RF transmitter. Referring to FIG. 3 and assuming a transmission mode using quadrature modulation, such as Wideband Code Division Multiple Access (W-CDMA) or Enhanced data rates for GSM Evolution (EDGE) for example, step 510 may be seen to correspond to output of I and Q signals from digital block 312 of transmitter 310. In transmitter embodiments such as that shown in FIG. 3 that additionally, or alternatively, support transmission modes using constant envelope polar modulation, such as Global System for Mobile communications (GSM) for example, step 510 my result in digital block 312 providing the generated digital signal to TX PLL 327.

Moving to step 520 in FIG. 5 while continuing to refer to transmitter 310 in FIG. 3, for transmission modes using quadrature modulation, e.g., W-CDMA or EDGE transmission modes, step 520 of flowchart 500 comprises converting the digital signal to an analog signal, such as an analog baseband signal for example, by a DAC. Step 520 may be performed by DACs 322a and 322b, and may be followed by filtering of the analog signal by respective adjustable LPFs 324a and 324b, which may be implemented as third-order Butterworth filters for example. In applications in which more than one transmission mode using quadrature modulation is supported, there may be fairly significant differences in the mode specific filtering performances required of adjustable LPFs 324a and 324b. For instance, where both W-CDMA and EDGE modes are supported, LPFs 324a and 324b may be called upon to provide an approximately 2.0 MHz bandwidth for W-CDMA but less than approximately 0.5 MHz of bandwidth for EDGE. As a result, LPFs 324a and 324b are made adjustable to accommodate adaptive reconfiguration in support of multi-mode transmissions.

Referring to step 530 of FIG. 5 in combination with transmitter 310, and again for the case of quadrature modulation, step 530 of flowchart 500 comprises up-converting the analog baseband signal filtered by LPFs 324a and 324b to an RF signal. According to the embodiment of FIG. 3, step 530 may be performed by either of mixers 326a or 326b working in conjunction with LOGEN 328, according to the frequency band selected for transmission. It is noted that mixers 326a and 326b may be implemented as passive mixers in various embodiments of the present invention.

As a specific example of step 530, where, as in FIG. 3, a transmitter is configured to support both high-band transmission and low-band transmission, one of respective mixers 326a or 326b may be employed to combine and up-convert the I and Q signals provided by respective adjustable LPFs 324a and 324b to generate a transmit signal of transmitter 310 at a transmit frequency, such as at RF. In one embodiment, a high-band transmit signal may have a transmit frequency in a range between approximately 1.9 GHz and 2.2 GHz, for example, while a low-band transmit signal may have a transmit frequency in a range between approximately 0.8 GHz and 1.1 GHz, for example.

Alternatively, in embodiments in which one or more transmission modes using polar modulation is supported, such as GSM mode, for example, DACs 322a and 322b, adjustable LPFs 324a and 324b, and mixers 326a and 326b are not needed for modulation. Consequently, in those embodiments, DACs 322a and 322b, adjustable LPFs 324a and 324b, and mixers 326a and 326b can be disabled during steps 510, 520, and 530, for example. Thus, in a transmitter operating in a polar modulation transmission mode, the digital signal corresponding to the transmit signal can be generated in digital block 312, in step 510, and may be fed to TX PLL 327, which can in turn consolidate steps 520 and 530 to provide the transmit signal in the form of inputs to variable gain control PA driver 330a or 330b, such as differential inputs provided through a buffer circuit (buffer circuit not shown in FIG. 3).

Continuing with step 540 of flowchart 500, step 540 comprises preamplifying the RF signal generated in step 530 by one of variable gain control PA drivers 330a or 330b to provide substantially all pre-PA gain control at the transmit frequency. Referring to FIG. 4, step 540 of flowchart 500 can be performed by variable gain control PA driver 430 for any transmission frequency and/or any transmission mode. For example, in transmission modes using quadrature modulation, variable gain control PA driver 430 receives up-converted differential inputs from mixer 426, corresponding to either of mixers 326a or 326b, in FIG. 3, and receives those inputs at a transmit frequency such as at an RF of greater than approximately 800 MHz, for example. Alternatively, in transmission modes using polar modulation, variable gain control PA driver 430 receives differential transmit frequency inputs from TX PLL 427.

Whether transmitting in high-band or low-band, or in a transmission mode employing quadrature or polar modulation, the transmit frequency inputs to variable gain control PA driver 430 are provided up to approximately 32 dB of gain control by each of variable gain transconductance amplifier 432 and variable gain current steering block 434, and up to an approximately 12 dB of additional gain control by variable gain output transformer 436. Consequently, substantially all of the approximately 80 dB or more of pre-PA gain control provided by transmitter 210, in FIG. 2, is provided by variable gain control PA driver 230, for example after up-conversion by mixer 226 in that figure.

It is emphasized that because substantially all pre-PA gain control is provided at transmit frequency, substantially no pre-PA gain control need be provided prior to or during up-conversion from baseband. As a result, the additional calibration iterations required by conventional architectures in which pre-PA gain control is distributed over higher frequency and lower frequency gain control stages can be omitted. For example, because substantially no gain control need be provided by DACs 322a and 322b, adjustable LPFs 324a and 324b, or either of mixers 326a or 326b, in FIG. 3, calibration and gain control among those features and respective variable gain control PA drivers 330a and 330b need not be coordinated, resulting in substantial reductions in calibration time and cost.

Moving on to step 550 of FIG. 5 and referring once again to transmitter 310 in FIG. 3, step 550 of flowchart 500 comprises providing the preamplified RF signal produced in step 540 at an input to PA 340. Referring to FIG. 4 and returning to the example embodiment in which each of GSM, EDGE, and W-CDMA transmission modes are supported, step 550 may be performed through appropriate switching at the output nodes of variable gain output transformer 436 (switching not explicitly shown in FIG. 4). For example, in GSM and EDGE modes, one of the outputs of variable gain output transformer 436 can be used to provide the single-ended input to PA 440, while the other transformer output is grounded. When operating in W-CDMA mode, by contrast, the opposite transformer output can be used to deliver the single-ended input to PA 440, while the first transformer output is AC-wise grounded. Thus a single implementation of variable gain control pre-PA driver 440 can be adapted to provide outputs suitable for a variety of transmission modes, further enhancing the compactness and operational efficiency of embodiments of the present invention.

Although not addressed by the example method of FIG. 5, as shown in FIG. 3, in some embodiments, a transmitter according to the present inventive principles includes feedback calibration stage 338. As depicted in FIG. 3, in those embodiments, the differential signals provided at inputs to the variable gain output transformer portion of variable gain control PA drivers 330a and 330b may be tapped off and directed through feedback calibration stage 338 and ADC 339 to digital block 312. In one embodiment, the feedback information provided through feedback and calibration stage 338 can be utilized by digital block 312 to enable self-calibration of transmitter 310, to further improve transmitter gain control accuracy and transmit performance.

Thus, by describing a transmitter architecture configured to provide substantially all pre-PA gain control at a transmit frequency, the present application discloses a transmitter enabling greater efficiency through reduced calibration time and cost. In addition, by shifting substantially all pre-PA gain control after up-conversion of a transmit signal, embodiments of the present invention enable a compact consolidated architecture capable of supporting multiple transmission modes and multiple transmission frequencies. Moreover, by concentrating substantially all pre-PA gain control in relatively few transmit frequency gain stages coupled to a feedback and calibration stage, the present application discloses a flexible and adaptive transmitter architecture enabling substantial self-calibration for improved gain control accuracy, thereby further enhancing transmitter performance.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

1. A radio frequency (RF) transceiver including a transmitter enabling efficient preamplification gain control, said transceiver comprising:
a receiver for processing a receive signal of said transceiver;
said transmitter including a power amplifier (PA), said transmitter configured to provide a pre-PA gain control for preamplifying a transmit signal of said transceiver;
wherein substantially all of said pre-PA gain control is provided when said transmit signal is at a transmit frequency of said transmitter.

2. The RF transceiver of claim 1, wherein said transmitter comprises a PA driver for preamplifying said transmit signal, wherein substantially all of said pre-PA gain control is provided by said PA driver.

3. The RF transceiver of claim 2, wherein said PA driver comprises:
a transconductance amplifier;
a current steering block;
an output transformer;
wherein each of said transconductance amplifier, said current steering block, and said output transformer provide a respective variable gain control to said pre-PA gain control.

4. The RF transceiver of claim 1, wherein said transmitter further comprises:
a digital-to-analog converter (DAC) for converting a digital signal corresponding to said transmit signal to an analog signal;
a mixer for up-conversion of said analog signal to generate said transmit signal;
wherein substantially all of said pre-PA gain control is provided after said up-conversion.

5. The RF transceiver of claim 4, wherein said mixer comprises a passive mixer.

6. The RF transceiver of claim 1, wherein said transmit frequency is greater than approximately 800 MHz.

7. The RF transceiver of claim 1, wherein said transmitter is a multi-mode transmitter configured to support a plurality of transmission modes.

8. The RF transceiver of claim 1, wherein said transmitter is a multi-band transmitter configured to support a plurality of transmit frequencies.

9. A radio frequency (RF) transmitter enabling efficient preamplification gain control, said RF transmitter comprising:
a power amplifier (PA) for amplifying a transmit signal of said transmitter;
said transmitter configured to provide a pre-PA gain control for preamplifying said transmit signal before said amplifying;
wherein substantially all of said pre-PA gain control is provided when said transmit signal is at a transmit frequency of said transmitter.

10. The RF transmitter of claim 9, further comprising a PA driver for preamplifying of said transmit signal, wherein substantially all of said pre-PA gain control is provided by said PA driver.

11. The RF transmitter of claim 10, wherein said PA driver comprises:
a transconductance amplifier;
a current steering block; and
an output transformer;
wherein each of said transconductance amplifier, said current steering block, and said output transformer provide a respective variable gain control to said pre-PA gain control.

12. The RF transmitter of claim 9, wherein said transmitter further comprises:
a digital-to-analog converter (DAC) for converting a digital signal corresponding to said transmit signal to an analog signal;
a mixer for up-conversion of said analog signal to generate said transmit signal;
wherein substantially all of said pre-PA gain control is provided after said up-conversion.

13. The RF transmitter of claim 12, wherein said mixer comprises a passive mixer.

14. The RF transmitter of claim 9, wherein said transmit frequency is greater than approximately 800 MHz.

15. The RF transmitter of claim 9, wherein said RF transmitter is a multi-mode RF transmitter configured to support a plurality of transmission modes.

16. The RF transmitter of claim 9, wherein said RF transmitter is a multi-band RF transmitter configured to support a plurality of transmit frequencies.

17. A method for use by a radio frequency (RF) transmitter including a power amplifier (PA) to provide a pre-PA gain control, said method comprising:
converting a digital signal corresponding to a transmit signal of said transmitter;
providing said pre-PA gain control for preamplifying said transmit signal before amplification of said transmit signal by said PA;
wherein substantially all of said pre-PA gain control is provided when said transmit signal is at a transmit frequency of said transmitter.

18. The method of claim 17, wherein said converting comprises a digital-to-analog conversion and an up-conversion;
said digital-to-analog conversion producing an analog signal corresponding to said transmit signal;
said up-conversion being performed by a mixer to generate said transmit signal from said analog signal;
wherein substantially all of said pre-PA gain control is provided after said up-conversion.

19. The method of claim 17, wherein said transmit frequency is greater than approximately 800 MHz.

20. The method of claim 17, wherein said transmitter is a multi-mode transmitter configured to support a plurality of transmission modes.
